(19) United States
(12) Patent Application Publication
(10) Pub. No.: US 2023/0320262 A1
(43) Pub. Date: Oct. 12, 2023

(54) COMPUTER VISION AND DEEP LEARNING ROBOTIC LAWN EDGER AND MOWER

(71) Applicant: Tysons Computer Vision, LLC, Sterling, VA (US)

(72) Inventors: Daniel WOO, Sterling, VA (US); Michael HOOI, Frankton (NZ); Evan HEETDERKS, Heidelberg (DE)

(73) Assignee: Tysons Computer Vision, LLC, Sterling, VA (US)

(21) Appl. No.: 18/131,692

(22) Filed: Apr. 6, 2023

Related U.S. Application Data
(60) Provisional application No. 63/328,054, filed on Apr. 6, 2022.

(51) Int. Cl. A01D 34/00; G05D 1/02; G06T 7/579

(52) U.S. Cl. CPC A01D 34/008; G05D 1/0246; A01D 2101/00; G05D 1/0278; G06T 7/579; G05D 1/027

(57) ABSTRACT

An autonomous vehicle for performing gardening tasks, the vehicle including a motorized wheeled chassis with at least one motor providing power to a plurality of wheels, at least one rotating wheel attached to the motorized wheeled chassis, a line or blade extending from the rotating wheel configured to perform a selected gardening task, at least one of a downward-facing camera or an outward-facing camera, and a processor configured to control processing related to determining a position of the motorized wheeled chassis, driving the at least one motor to move one or more of the plurality of wheels, rotating the at least one rotating wheel when the selected gardening task is performed, and correcting a path of the motorized wheeled chassis based on one or more images obtained from the at least one of the downward-facing camera or the outward-facing camera.

### CROSS-REFERENCE TO RELATED APPLICATIONS

This application is based on and claims priority to provisional application 63/328,054 filed on Apr. 6, 2022. The entire content of the priority application is incorporated herein by reference.

### BACKGROUND

The present invention relates to a robotic lawn edger, mower, and garden assistant configured to perform lawn edging, mowing, and other gardening tasks including weeding under various conditions using computer vision and deep learning that is trained on simulated and real-world environments of use.

### SUMMARY

According to an aspect of the present invention, a motorized wheeled chassis is configured to move and turn in multiple directions using movement wheels. The motorized wheeled chassis includes components mounted to the chassis that are configured to perform lawn edging, mowing, weeding, or other gardening tasks. One or more electronic components are configured to obtain data regarding a surrounding area and control performance of lawn edging, mowing, weeding, or other gardening tasks.

According to another aspect of the present invention, the motorized wheeled chassis is controlled during the performance of the lawn edging, mowing, weeding, or other gardening tasks using determinations related to similarity of present conditions of the motorized wheeled chassis when compared to simulated environmental conditions, previously experienced conditions of the motorized wheeled chassis, or previously experienced conditions of other autonomous vehicles that have obtained comparable data regarding their respective surrounding areas.

In addition, according to aspects of the present invention, the electronic components of the motorized wheeled chassis may address a problem that can occur with self-positioning using an IMU (inertial measurement unit) by using additional sensor data (such as image data and/or depth data) as inputs to a neural network. Image data may include color images of a boundary between grass and non-grass materials and/or depth images indicating three-dimensional features surrounding the chassis.

Outputs of the neural network may include an angular value indicating a degree of misalignment with a boundary and a value indicating an amount of lateral offset from the boundary. Other outputs of the neural network may include a result of a corner detection algorithm, which may further indicate a distance from the chassis to the detected corner and an angle of the detected corner. The outputs of the neural network may be used as feedback for self-positioning of the motorized wheeled chassis.

### BRIEF DESCRIPTION OF DRAWINGS

FIG. 1 illustrates an embodiment of a motorized wheeled chassis.

FIG. 2 illustrates an example of a charging device for the motorized wheeled chassis according to an embodiment.

FIG. 3 is an embodiment of a mobile application used to control the motorized wheeled chassis and display information obtained from the motorized wheeled chassis.

FIG. 4 is a schematic diagram illustrating an example of a front end of a SLAM algorithm.

FIG. 5 is a schematic diagram illustrating an of a back end of a SLAM algorithm.

FIG. 6 is a flow chart illustrating steps of a process for performing an edging task.

FIG. 7A-7G show plan views of a motorized wheeled chassis performing an edging task.

FIG. 8 is a block diagram including examples of electronic components provided on the chassis.

### DETAILED DESCRIPTION

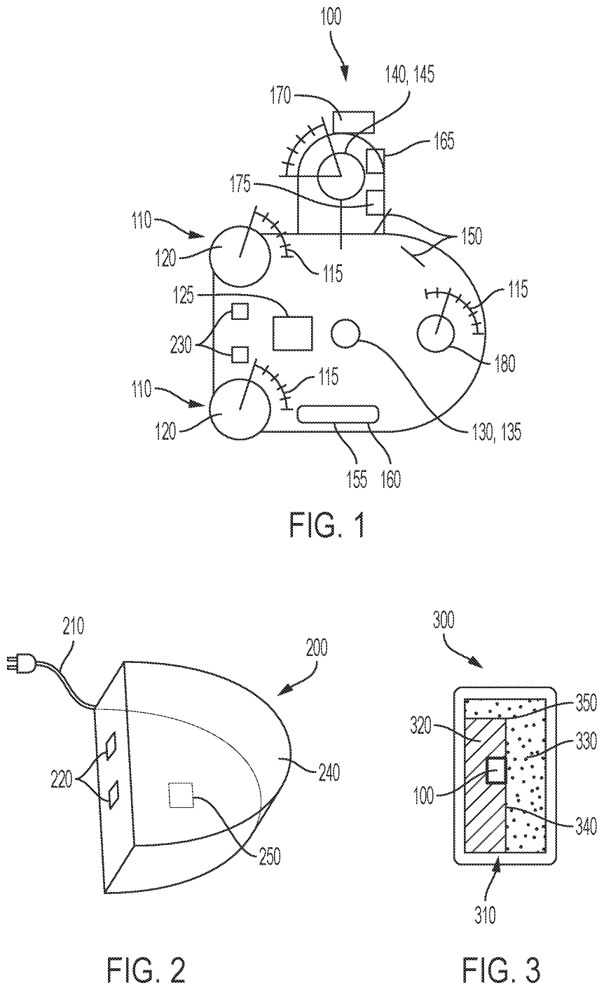

An embodiment of a motorized wheeled chassis 100, also referred to as a robot, is illustrated in FIG. 1. In an embodiment, the motorized wheeled chassis 100 may be configured to move translationally in multiple directions, including forward and backward directions in an embodiment, or to move translationally in only the forward direction, using movement wheels 110. The motorized wheeled chassis 100 is further configured to turn in a rotational manner. The translational movement and the rotational turning of the motorized wheeled chassis 100 may be performed simultaneously or as distinct operations.

Each movement wheel 110 may be controlled independently in order to perform the movement operations. The independent control of each movement wheel may be implemented by providing a separate motor 120 for each movement wheel 110, or may be implemented by a number of motors 120 less than a number of movement wheels 110 by delivering power to the movement wheels 110 via at least one transmission element 125. One or more free-spinning wheels 180 may also be provided.

According to an embodiment, a first rotating wheel 130 is mounted horizontally below the motorized wheeled chassis 100. The first rotating wheel 130 may be configured to feed one or more cutting lines 135 to cut grass while performing a mowing task. The one or more cutting lines 135 used to cut grass (i.e., perform mowing task) may be formed of a suitable material, such as plastic or metal. The one or more cutting lines 135 may also be replaced with plastic or metal blades. The first rotating wheel 130 may be mounted horizontally in order to maintain a predetermined grass cutting angle or to tilt in order to adjust a cutting angle. The first rotating wheel 130 may also be mounted vertically with blades extending in a horizontal direction of an axis of rotation of the first rotating wheel 130.

The movement wheels 110 are configured in an embodiment to be connected to the chassis 100 in a manner that the chassis 100 including the first rotating wheel 130 can be raised and lowered using a height adjuster 115 to adjust a grass cutting height or to adjust a clearance beneath the chassis 100. The height adjuster 115 may be electronically controlled or may be a manual adjustment mechanism for a user to adjust a distance between the chassis 100 and each movement wheel 110. Furthermore, a distance between the chassis 100 and the first rotating wheel 130 may be changed in order to adjust the grass cutting height.

According to an embodiment, a second rotating wheel 140 is mounted vertically to the motorized wheeled chassis 100. The second rotating wheel 140 may be configured to feed one or more edging lines 145 to edge grass while performing a lawn edging task. The second rotating wheel 140 may be mounted vertically on a side of the chassis 100. The one or more edging lines 145 may also be replaced with plastic or metal blades. The second rotating wheel 140 may be mounted vertically in order to maintain a predetermined edging angle, such as maintaining a parallel relationship with respect to a forward direction of the chassis 100, or to tilt in order to adjust the edging angle. The second rotating wheel 140 may be configured to be raised and lowered to adjust edging depth, or to provide additional clearance when the edging task is not being performed. The second rotating wheel 140 may also be mounted horizontally with blades extending in a direction of an axis of rotation.

In an embodiment, a counterweight 155 and/or battery pack 160 may be placed on an opposite side of the chassis 100 with respect to the second rotating wheel 140 in order to balance the chassis 100. The rotating wheels 130 and 140 with cutting lines 135 and edging lines 145 may also be replaced with one or more spinning metal blades, or blades made of another suitable material. The counterweight 155 may not be needed, depending upon a weight and configuration of the one or more lines or blades, and weight and configuration of a battery pack 160 and/or a computer of the electronic components 165 may be provided at locations determined in order to achieve the balancing effect of the counterweight noted above, in part or entirely. That is, the battery pack 160 and/or the computer of the electronic components 165 may replace the counterweight or may be provided in selected locations that assist with stabilizing and balancing the chassis 100, while this effect is further supplemented by the counterweight 155.

According to an embodiment, the first rotating wheel 130 and the second rotating wheel 140 may be configured with a mounted razor blade 150 mounted in the path of a maximum length of each cutting line 135 or edging line 145 to cut the one or more lines to a maximum length from the first rotating wheel 130 and the second rotating wheel 140. Each rotating wheel 130 and 140 may be configured with an automatic feeding mechanism 185 to keep the one or more cutting lines 135 and the one or more edging lines 145 near the maximum length from a respective rotating wheel.

The battery pack 160 may be provided to supply power to the motors 120 in order to drive the movement wheels 110 and the rotating wheels 110. The battery pack 160 may also supply power to the electronics components 165 used to control timing and duration of driving the various motors 120, and also supply power to sensors of the electronic components 165 used to obtain sensor data used as inputs in a control process.

One or more outward-facing two-dimensional (2D) or three-dimensional (3D) cameras 170 may be mounted above the chassis 100 in an embodiment. The one or more outward-facing cameras 170 may include at least two outward-facing cameras 170 that obtain a stereoscopic image by calibrating the outward-facing cameras 170 together to determine distance information, using techniques such as creating disparity maps. A distance sensor of the electronic components 165 may be optionally configured to determine distance information. In an embodiment, at least one downward-facing camera 175 may be mounted below the chassis 100. Images obtained by the one or more outward-facing 2D or 3D camera(s) 170 and the at least one downward-facing camera 175 are sent to the computer. The images sent to the computer may further include the optional distance information determined by the distance sensor. In an embodiment, the one or more outward-facing 2D or 3D cameras 170 may include at least one forward-facing camera, at least one backward-facing camera, and/or at least one camera side-facing camera.

According to an embodiment, the electronics components 165 include a computer mounted on the chassis 100, the computer having a central processing unit (CPU) and/or a graphics processing unit (GPU). The computer including the CPU and/or GPU may be configured to communicate with on-board sensors or external sensors to detect the following items: (1) a path to follow to edge grass; (2) when poorly edged grass needs to be re-edged; (3) a path to follow to cut grass; (4) when poorly cut grass needs to be recut; (5) steps to be performed during other gardening tasks including weeding, which may include recognition and prioritization of plant materials in order to remove undesired plants with or without user input, and (6) a path to a charging station 200 to charge the battery pack.

The charging station 200 according to an embodiment is illustrated in FIG. 2 and may include a power cord 210 to plug into an outlet, charging contacts 220 on the charging station 200 corresponding to charging contacts 230 provided on the chassis, and a rain cover 240 to protect the charging station 200.

The computer may also be configured with wireless communications such as wifi, cellular connection, or other wireless communication protocol to connect to a network via the electronic components 165 to send the images obtained by the 2D and/or 3D cameras 170 and 175 to an application or website having a user interface 310, an embodiment of which is shown displayed on user device 300 in the embodiment illustrated in FIG. 3. The application or website may be operated using the user interface 310 on user device 300, which may be a smartphone or a separate computer. The application or website may cause the user device 300 to display images of a lawn including grass 320 and/or a non-grass material 330 adjacent to the lawn to a user through the user interface 310. The application or website may also be used to provide input via the user interface 310 regarding a position of the chassis 100, identification of zones in which the chassis performs designated edging, mowing, weeding, and/or other gardening operations, identification of plants, and selection of operations or prioritization related to identified plants. The user interface 310 may also indicate a current location of the chassis 100, which may be shown in relation to features of the surrounding environment including a boundary 340 between grass 320 and non-grass 330, as well as a corner 350 of the lawn zone including the grass 320.

The wifi, cellular connection, or other wireless communication protocol included in the electronic components 165 may be used to open a garage or a door to facilitate access to the charging station 200.

The computer may also be configured to process data received from a global positioning system (GPS) receiver provided with the electronic components 165. Data from the GPS receiver may be transmitted to the application or website in order to display a location of the chassis 100 using the user interface 310. Using a map such as a GPS map or other type of map representing an environment in which the chassis is to operate, the application or website can also be used to set a geofence to keep chassis 100 inside and set zones including areas with grass 320 for the chassis 100 to edge and/or cut. An IMU or the GPS can also be used to follow a path for the chassis 100 determined during each selected operation. Using the user interface 310 of the application or website, the user can set a desired frequency to perform selected tasks among the lawn edging, mowing, weeding, and other gardening tasks.

The computer may be trained using computer vison and deep learning to recognize weeds. When weeds are recognized, the computer may control one or both of the rotating wheels 130 and/or 140 to cut the weeds down to the root during a weeding task, using the one or more lines 135 or one or more lines 145 fed to the rotating wheels 130 and 140. The user can also add images of weeds for the computer to learn where to perform the weeding task, or may provide feedback in the user interface 310 regarding whether a plant contained in an image provided by one of the cameras is desirable or undesirable, or input priorities of identified plants that may be associated with closeness values for how close the chassis 100 may approach in proximity to the identified plants.

The computer may be trained using computer vision and deep learning based on simulated environments and previously experienced environments of the same chassis 100 or other vehicles to recognize conditions of an environment surrounding the chassis 100. The conditions of the environment that may be recognized by the computer include presence and location of objects, presence and location of people, and weather conditions. The recognized conditions of the environment may be used to control various tasks performed by the robot.

In an embodiment, the computer may be configured to communicate with a non-transitory computer-readable storage medium that stores information including past color and/or depth images, a corresponding representative of one or more past images, or past location history obtained from the GPS receiver. The computer may be further configured to compare the stored information to current information using a similarity computation to determine a most likely location of the chassis 100.

In a conventional product, one or more guide wires or markers have been used to contain a path of a motorized vehicle. The conventional product may use random or computed paths within the one or more guide wires or markers to cut grass and may follow the one or more guide wires to edge.

According to an embodiment of the present disclosure, the motorized wheeled chassis 100 is configured to perform the lawn edging, mowing, weeding, and other gardening tasks without requiring a guide wire or marker to determine a boundary within which the tasks are to be performed. Instead, in an embodiment, the lawn edging, mowing, weeding, and gardening tasks are controlled using computer vision and deep learning, and control may be implemented using input from an IMU, a GPS receiver, or other self-positioning module, along with appropriate correction as described in detail below.

The computer may be further configured to use computer vision and deep learning to detect when to re-edge and when to recut. Computer vision and deep learning may be performed independently by the computer and/or network server communicating with the computer, or may be performed using feedback from the user or from one or more other users.

Computer vision and deep learning models are used to steer the chassis 100 by inputting 2D and/or 3D images into a deep learning model and outputting the heading of the chassis to (1) approach the lawn edge for edging, (2) edge the lawn edge, (3) approach the lawn grass for cutting, (4) cut the lawn grass, (5) determine whether previously edged lawn satisfies a condition that triggers the lawn to be re-edged, (6) determine whether previously cut lawn grass satisfies a condition that triggers the lawn to be recut, (7) determine whether a plant is an undesirable weed to be removed, (8) determine a priority of desirable plants in order to maintain an appropriate distance during weeding or other gardening tasks, and (9) approach and dock with the charging station.

The deep learning model can also output whether or not to spin the rotating wheels 130 and/or 140 used for edging and/or cutting at a determined position of the chassis. Alternatively, a path tracking algorithm run by the computer can be used for this purpose.

Before actual use, the computer vision and deep learning models may be trained on (1) a dataset of images that represent the images that could be found in actual use, (2) corresponding heading for the chassis, and (3) optionally, correspondingly, whether to spin the edging and/or cutting wheels. The images may be color or grayscale. 3D images are like 2D images, except some or all pixels will have distance from camera data associated with the pixels.

In addition, a supervisor algorithm runs one or more of the previous models and decides which model to follow with the goal of having a cut and edged lawn and returning the chassis to the charging station when done. The supervisor algorithm may also incorporate standard path computing algorithms to move with assistance from GPS position or image similarity location obtained using the similarity computation or from a previous location and predicted movement algorithm.

In an embodiment, a tilt sensor may be provided to detect a tilt angle of the chassis. When the tilt sensor detects that the chassis is tilted beyond a threshold tilt angle, the computer may be configured to control the motor(s) used with the movement wheel(s) in order to stop or reverse movement of the chassis. When the tilt sensor detects that the chassis is tilted beyond the threshold tilt angle, the computer may also be configured to stop spinning one or both of the rotating wheels with lines or blades. The tilt angle of the chassis may also be used to determine a tilt of each rotating wheel.

Modes of Operation:

Initial setup to determine one or more zones and a perimeter of each determined zone.

Lawn edging including edging a perimeter of a lawn.

Lawn mowing including cutting of grass in the lawn to a user determined height.

Ornamental weeding including removal of weeds in a zone including ornamental plants.

Garden weeding including removal of weeds in a zone including fruit or vegetable plants.

SLAM and GEOFENCING: A simultaneous localization and mapping (SLAM) module included in the computer of the electronic components 165 may operate using at least one of the outward-facing camera(s) 170 or the downward-facing camera(s) 175, by implementing at least one of an iterative closest point (ICP) or an ORB feature selection algorithm to find keypoints in the scene that will be used for localization of the chassis 100 and mapping of the surrounding environment. In an alternative embodiment, only one camera that is both forward-facing and downward-facing may be provided in order to obtain images used to control operation as discussed in further detail below.

When the system is initially set up by the user, the user may drive the chassis 100 around the perimeter of each zone that needs to be mowed or edged. When the user reaches a new zone, the user may provide an input using the user interface 310 to indicate that they are beginning mapping of a new zone, and they will provide another input when they have finished mapping the perimeter of the zone.

When the user is driving the robot along a segment that needs to be edged, they may also toggle a button in the user interface 310 which indicates to the computer that this segment of the perimeter needs to be edged. The output of this process will be a path in 2D space that indicates the perimeter of the zone. Alternatively, the robot may perform the initial setup autonomously by executing an initiation process of determining a perimeter without external user input, the perimeter determination being performed by recognizing a boundary 340 between grass 320 and non-grass 330 materials.

When the robot is operating autonomously according to an embodiment, it may start by navigating the perimeter path. When it is on a segment that is determined to require edging, the computer will query the edging module to see if any corrections need to be made for its path. If the edging module outputs corrections, then these corrections will be used to adjust the perimeter path for the future.

Eventually, the edging module will not have to provide large corrections to the path, as they will be incorporated into the perimeter path.

In order to address a problem occurring with drift based on self-positioning using an IMU or GPS module, correction of the self-positioning can be performed using an algorithm such as an ICP (iterative closest point) so that a depth camera of the outward-facing camera(s) 170 obtains different three-dimensional features and maps these features using XYZ points. A new set of XYZ points mapped to the three-dimensional features surrounding the robot can be obtained at various positions according to an ICP sampling frequency. By comparing the XYZ points from a previous sample to the XYZ points of a current sample, it is possible to determine a relative distance between points. The relative distance between the respective XYZ points can be used to determine a relative pose difference between a point at which a previous sample was obtained and a point where a current sample is obtained. This relative pose difference can then be used to correct errors that may occur due to the IMU position estimation.

That is, the IMU is used primarily to determine a position of the motorized wheeled chassis or robot, and then the position determined by the IMU is corrected via an algorithm such as ICP, which establishes a relative pose difference between the samples including XYZ points represented as a depth map of the three-dimensional features surrounding the motorized wheeled chassis at the respective points corresponding to the respective samples. Optimization can be performed on the depth maps to obtain high-fidelity measurements so that selected sampling points can be used as nodes in a graph representing a position of the motorized wheeled chassis.

First, a map of the environment surrounding the motorized wheeled chassis at each point can be stored as a graph of the XYZ points. Subsequently, previous points or redundant nodes within the graph can be pruned, depending upon a degree of overlap between features in the mapping performed at each point or node. That is, in order to conserve computing resources, it may be preferable to have a certain degree of overlap between features that are visible from different nodes so one node can see some part of the surrounding scene, and another can see another part of the surrounding scene. With sufficient overlap, it is possible to establish the relative difference in pose of the motorized wheeled chassis between the different nodes, but with too much overlap, the cost of computing resources required to store the two different nodes may be too high given the redundancy of the depth map information.

The electronics associated with the motorized wheeled chassis can perform an algorithm to determine whether a loop is closed in order to decide whether the motorized wheeled chassis has returned to a point at which it started by using the ICP procedure to verify that a node corresponding to a present location of the chassis 100 is a previously visited node by comparing relevant nodes. The more nodes used in the comparison, the more resource-intensive the comparison operation will be, so there is a trade-off between accuracy achieved through density of the nodes in the depth map and corresponding complexity of the comparison operation.

An ORB feature selection algorithm may be used in place of or in addition to the ICP to correct the IMU and/or GPS self-positioning and to provide corresponding nodes to a SLAM library that may then be used during subsequent location and mapping operations. Using the ORB feature selection algorithm, a point cloud from one location may be compared to another point cloud from another location. Then, the computer may attempt to merge the two point clouds to establish the relative pose difference simply based on RGB values. Detected features to be stored in the point clouds may include corners, edges, and/or other high-contrast objects that are easily distinguishable from one image to another. Regardless of which algorithm is used to for correction in an embodiment, it may be beneficial to balance the cost of the necessary computer resources with available processing power in order to achieve optimal computing efficiency while providing high-fidelity self-positioning of the robot.

When a user initially uses the robot according to an embodiment, the user may set up the charging station at a location in proximity to zones in which gardening tasks are to be performed, and then the user may initiate the user interface to control the robot to drive around the perimeter of the different zones that the user wants to map. The robot performs mapping using the IMU and/or GPS corrected by ICP point clouds using depth map data and/or ORB feature recognition as the robot proceeds around the perimeter. By using those corrections, the SLAM library of the perimeter map may be updated in order to achieve a higher degree of accuracy.

When the robot returns to the point that it started, the user can provide an input in the user interface to indicate that mapping of the perimeter is finished. The external confirmation provided by the user input may confirm a location of a node, and the confirmed location may then be considered an anchor point which is given a higher weighting than other nodes indicated within the SLAM library. It may be desirable to conserve computing resources by running a loop closure algorithm at discrete locations, such as locations corresponding to anchor points, although the loop closure algorithm may also be performed continuously as part of the mapping process.

Once the robot establishes a perimeter path of a zone, the edging module may operate along this perimeter path, a mower module may operate within an interior of the zone, or a weeding module may operate within the interior of the zone.

According to an embodiment, images obtained by the downward-facing camera can be saved in addition to the data points from the outward-facing camera(s) so that a robot may establish its bearings based not only on surrounding objects, but also based on features located beneath the robot. Features can be determined using image segmentation based on what is underneath the robot, and images obtained by the downward-facing camera(s) may be recorded in the slam library in conjunction with images obtained by the outward-facing camera(s) in order to establish a correspondence relationship.

A SLAM algorithm will be used to perform localization and mapping, which are vital for the robot to perform its tasks. As noted above, on setup, the robot may start in its charging station 200. The charging station 200 may be considered the origin point of the world coordinate system (i.e. point (0, 0, 0) in 3D space) defined for the robot.

In a manual setup mode according to an embodiment, the user may drive the robot to the edge of a zone. Once at the edge of the zone, the user may provide input to the user interface 310 to notify the control system of the robot that it should record the perimeter of a new zone, and then the user will start driving the robot around the perimeter of that zone. Meanwhile, the SLAM module will be generating a map of the environment and provide locations in the world coordinate frame. Once the user returns to the starting point of the perimeter of a current zone, the user will notify the system that they have finished outlining the zone, and this information will be passed to the SLAM algorithm to perform loop closure which will connect the final node in the pose-graph with the first node. Once a zone is complete, the user may drive the robot to the next zone and repeat the process or indicate that all zones have been mapped.

The SLAM algorithm can be broken up into two basic parts: the front end and the back end. The front end of the SLAM algorithm is responsible for generating relative pose differences between different sensor measurements, and these relative pose differences can be calculated in a variety of ways. If computation is limited, then the iterative closest point (ICP) algorithm will be applied to the point clouds generated from depth map data generated by the depth camera. If more computation is available, then the system may also include ORB features from the RGB camera to track feature points in the environment. The robot may also be equipped with an inertial measurement unit (IMU) which, by performing double integration of the accelerometer and integration of the gyroscope, can propose an initial estimation of a relative pose difference. This initial estimation of the relative pose difference may be used as a starting transformation for the ICP algorithm and/or the ORB feature matching algorithm. According to an embodiment, once the ICP and ORB algorithms converge to a pose transformation, a new node can be added to the pose graph and connected to a previous node using this transformation.

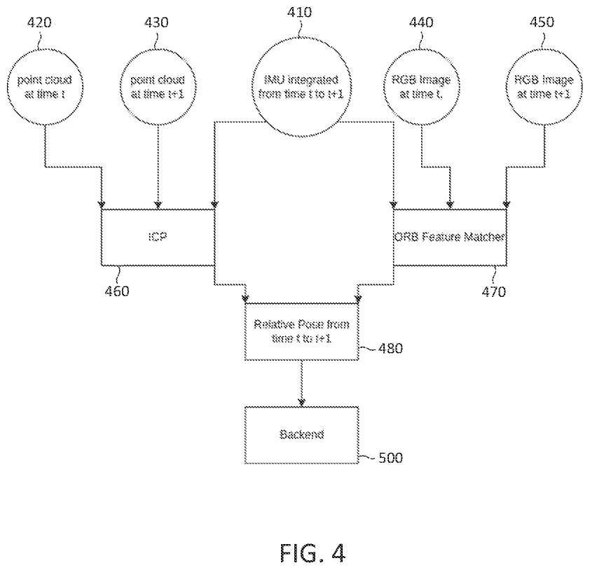

FIG. 4 provides a schematic outline of the front end of the SLAM algorithm according to an embodiment. An IMU may integrate the inertial inputs noted above from time t to a subsequent time t+1, as indicated at 410. The ICP 460 may receive an output of the IMU integration to use as an input along with a point cloud 420 generated at time t and a point cloud 430 generated at time t+1. The ORB feature matcher 470 may also receive the output of the IMU integration to use as an input along with an RGB image 440 generated at time t and an RGB image 450 generated at time t+1. Outputs from the ICP 460 and the ORB feature matcher 470 may be used to determine a relative pose difference of the robot between time t and time t+1, as indicated at 480, and the determined relative pose difference may be provided to a back end 500 of the SLAM algorithm.

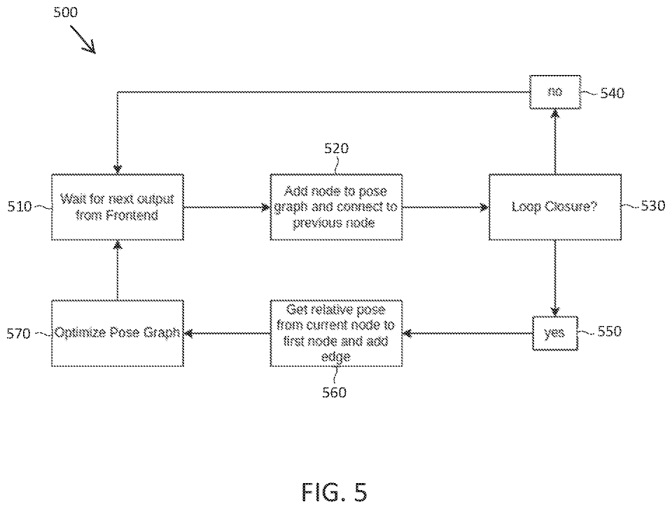

The back end 500 of the SLAM algorithm optimizes the pose graph, which consists of nodes for every sensor measurement and edges that describe the relative transformation between each successive node. FIG. 5 provides a schematic outline of the back end of the SLAM algorithm according to an embodiment. An output from the front end of the SLAM algorithm is received at step 510, at which point a node is added to the pose graph and connected to a previous node as indicated at step 520. When it is determined at step 530 that a loop has not been closed, the process returns to wait for a next output from the front end, as indicated at step 540. When it is determined at step 530 that the loop has been closed, the process proceeds as indicated at step 550. That is, upon determining loop closure, the back end of the SLAM algorithm determines a relative pose difference from a current node to a first node and adds an edge, as indicated at step 560. The process then continues by optimizing the pose graph based on the determined relative pose difference, as indicated at step 570.

Once the user finishes driving around a perimeter of a zone, the user may notify the system via the user interface that the robot has returned to the starting point, and the final node in the pose graph will be connected to the first node in the pose graph using the ICP and ORB feature matcher, as discussed above. Inevitably, the SLAM module will have accumulated some drift while mapping the perimeter, which will result in the system believing it is farther away from the starting point than it actually is. Once the final node is connected to the first node, this error will be corrected by optimizing the entire pose graph so that the error between connected nodes is minimized.

The system contemplated by the present disclosure provides improved efficiency compared to a conventional SLAM algorithm, because a system based on the present disclosure may be configured to only perform loop closure when the user tells the robot that it has returned to a point it has seen before. In conventional SLAM algorithms, a CPU core is dedicated to continuously detecting loop closure, which involves comparing the current sensor outputs to all previous sensor outputs. This is both computationally expensive and error-prone.

While the user is driving the robot around the perimeter, the system will record locations along the perimeter that will be used to geofence a zone. These points will be used as waypoints for the edging module. As the edging module corrects for errors between the robot's location and the actual edge of the zone, these waypoints will be updated for future edging, mowing, weeding, and other gardening tasks.

LAWN EDGING: For the edging task, the chassis may utilize at least one downward-facing color (RGB) or grayscale camera 175, and at least one outward-facing camera 170 that may include a depth camera, as shown in FIG. 1.

During the edging task, the downward-facing camera 175 observes a boundary between an area with a non-grass material 330 that may consist of dirt, concrete, or other material, and an area with desirable plant material of a lawn such as grass 320. The downward-facing camera has visibility into an area in front of the chassis 100 and an area behind the chassis in order to obtain, during an edging operation, an image including areas that have been edged as well as areas that have yet to be edged.

The resulting camera image from the downward-facing camera is fed into a deep neural network, like a convolutional neural network (CNN) to assist with recognition of various materials and image segmentation. The deep neural network is configured and trained using training data from simulated environments and/or real-world experience of the same chassis or other vehicles, such that outputs of the neural network may include: (1) at least one angular value indicating a degree of misalignment from the boundary 340; (2) a scalar value indicating degree of lateral offset from the boundary 340; (3) a binary value indicating whether or not a corner 350 is detected; (4) a scalar value indicating a distance to a detected corner 350; and (5) a scalar value indicating an angle of the detected corner 350.

Thus, the deep neural network outputs the information needed to maintain an appropriate pose of the chassis 100 with respect to the boundary 340 such that the one or more edging lines 145 attached to the second rotating wheel 140 can trim any plant material such as grass 320 outcropping beyond the boundary 350 into the non-grass area 340, but without trimming into the plant material area itself.

Using a control system, the edging task will thereby loop through the following steps: take a camera snapshot with the downward-facing camera 175 at a current position and run the obtained image through a deep neural network; obtain angular and translational correction values for the determined spatial pose of the chassis 100; make spatial corrections to the pose of the chassis 100 using a propulsion system such as via the movement wheels 110 driven by motor(s) 120; share sensor information with a SLAM (simultaneous localization and mapping) library; and make a subsequent movement in the forward direction while continuing the edging task before taking another camera snapshot with the downward-facing camera and repeating the steps as appropriate under the determined conditions.

While the above is taking place, the outward-facing camera(s) 170, which may include a depth camera according to an embodiment, share one or more obtained images with an internal SLAM library that uses the respective visual odometry (i.e. distance covered) to map the boundary 350 being trimmed in a cartesian coordinate system. This information can be saved for other gardening tasks.

During the edging task, the robot may start at a corner of a lawn and then use the downward-facing camera 175 to overlook the boundary 340 where the grass 320 abuts the non-grass material 330 such as concrete or dirt. In one use case according to an embodiment, the robot may follow a path to stay on the grass 320 side of the boundary 340.

During use, the chassis 100 starts moving along the boundary 340. After moving for a predetermined distance, the downward-facing camera obtains an image that is input into the deep neural network. Outputs of the neural network include scalar values, the first being an angle of misalignment of the chassis 100 with respect to the boundary 340, and the second being the lateral distance that the chassis 100 is offset from the boundary 340. These two scalar outputs noted above are fed back into a drive system to maneuver the chassis 100 using those scalar values to get back into a position that is aligned with the boundary while minimizing lateral offset.

In an embodiment, the system makes an adjustment based on the scalar outputs as noted above before moving forward again. After the subsequent forward movement, the system again stops and uses an image from the downward-facing camera to compute the two scalar values noted above. It is also possible for the system to continuously move while taking images with the downward-facing camera that are fed into the deep neural network, receiving the scalar value outputs from the neural network, and adjusting a path of the robot as appropriate while the robot continues to move.

A deep neural network may consist of a modified neural network that uses earlier layers in the network to detect edges. The neural network may be trained on simulated image data and/or real image data, and the real image data we be used to generate additional data using artificial intelligence so that a real world data sample can be altered to generate the additional data to account for variations in appearance of materials such as grass, concrete, or dirt. For example, the generated additional image data may be based on the appearance of each material during different seasons. That is, seasonal changes in the 3D model may be accommodated and predicted, like trees losing leaves and grass turning brown. Changes in lighting due to time of day and cloud cover are also accommodated and predicted.

The deep neural network may also cut out or truncate layers toward an end of the network. The shared layers that have already been trained earlier in the network include low-level features for detecting the edges. In an embodiment, another neural network or the same neural network may be trained to detecting corners uses those same edge features that have already been trained.

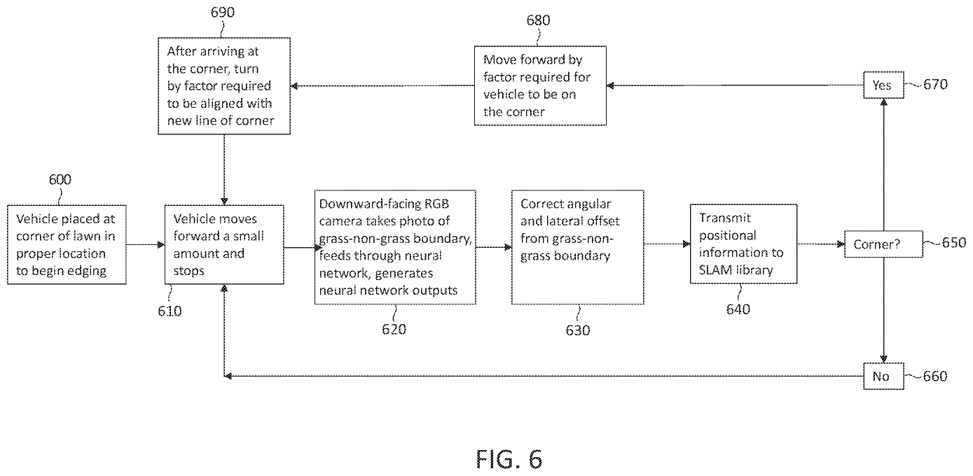

FIG. 6 is a flow chart illustrating an embodiment of a process for performing an edging task with or without previous determination of a perimeter of a lawn. At step 600, a vehicle such as chassis 100 is placed at a corner of the lawn to be edged in a proper location to begin edging. At step 610, the vehicle moves forward by a predetermined incremental amount while performing the edging task with an edging module such as the second rotating wheel 140 that spins to cause one or more edging lines 145 to edge the grass and other plant material of the lawn as the vehicle moves. After moving by the predetermined incremental amount, the vehicle stops.

At step 620, a downward-facing camera takes a photo of a boundary between a grass material and a non-grass material at a current location where the vehicle has stopped. The photo is transmitted from the downward-facing camera to electronic components attached to or otherwise associated with the vehicle in order to feed the photo through a neural network, which generates neural network outputs including angular value indicating a degree of misalignment from the boundary, a scalar value indicating degree of lateral offset from the boundary, a binary value indicating whether or not a corner is detected, a scalar value indicating a distance to a detected corner, and a scalar value indicating an angle of the detected corner.

At step 630, the electronic components of the vehicle execute algorithmic processing based on the angular value indicating the degree of misalignment from the boundary and the scalar value indicating the degree of lateral offset from the boundary in order to correct an angular offset and a lateral offset from the boundary between the grass material and the non-grass material. After correction, at step 640, the electronic components transmit positional information related to the corrected position of the vehicle to a SLAM library that stores nodes or waypoints related to known positions of the vehicle.

At step 650, the electronic components of the vehicle determine based on the binary value output by the neural network whether a corner is detected. When a corner is not detected, as indicated at step 660, the process returns to step 610 and the vehicle moves forward again before stopping to take another photo that is used to generate additional neural network outputs as discussed above.

When a corner is detected, as indicated at step 670, the process proceeds to step 680, at which point the vehicle moves forward by a factor or amount required for the vehicle to be located at the detected corner. After arriving at the corner, at step 690 the vehicle turns by a factor required to be aligned with the new line of the detected corner, and the process returns to step 610. The process may be repeated until the vehicle returns to the point at which it was initially placed at step 600, or until a user terminates the process.

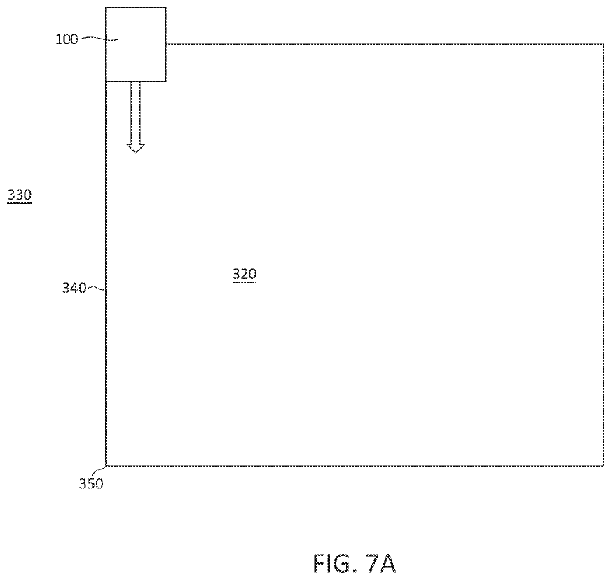

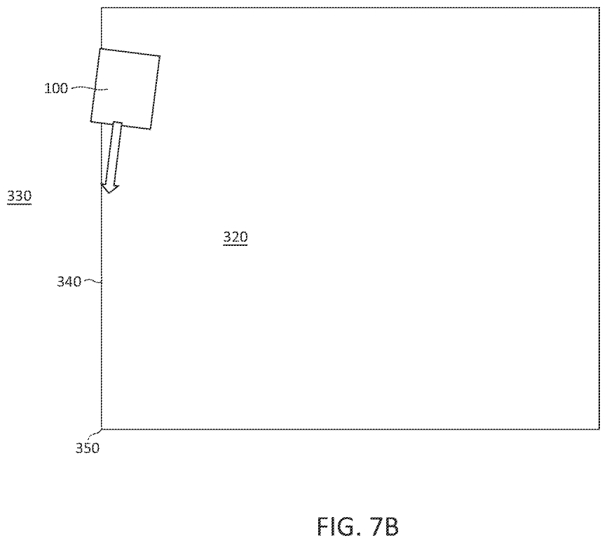

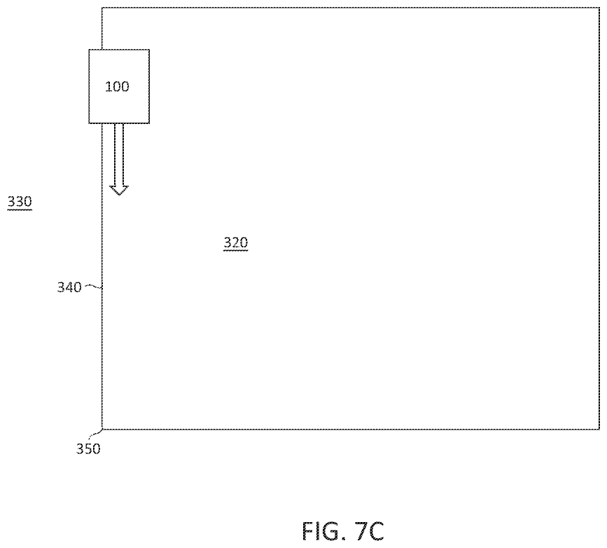

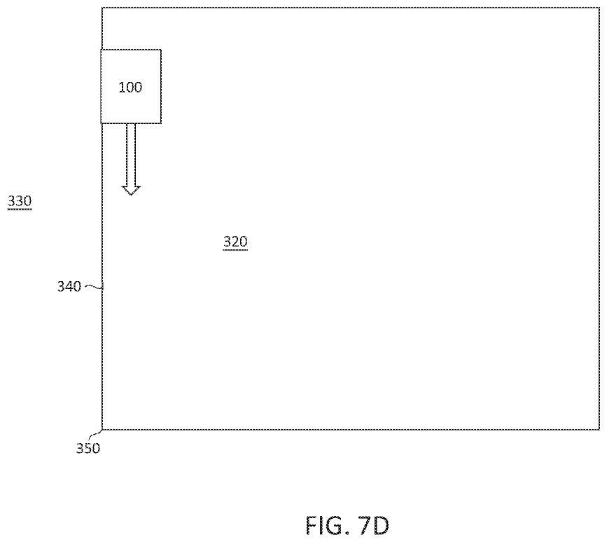

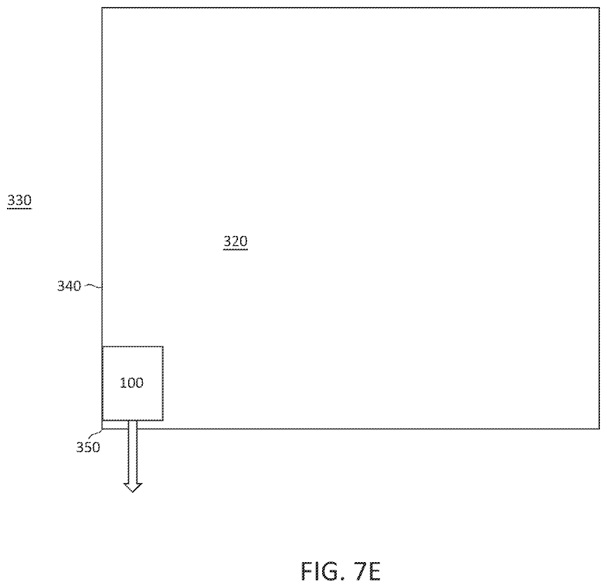

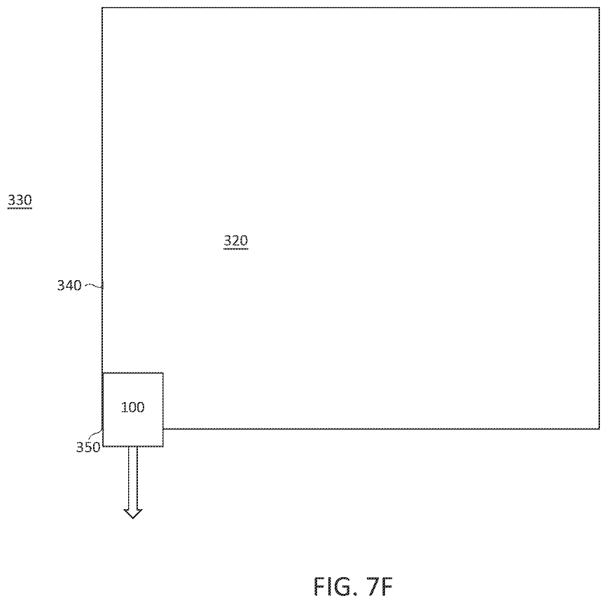

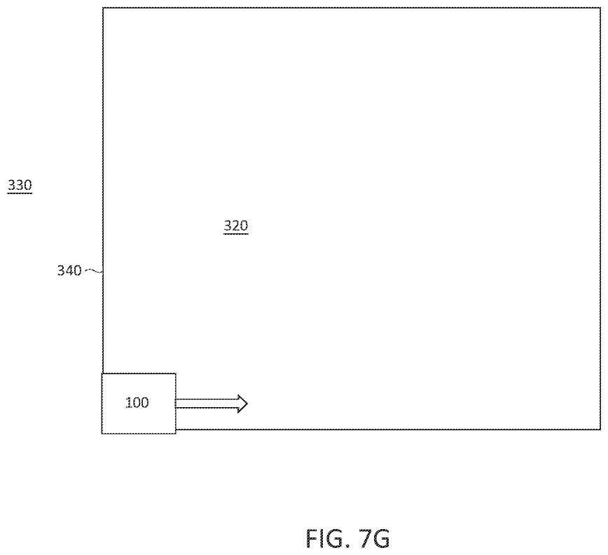

FIGS. 7A-7G illustrate a use case in which the vehicle performs the edging task. FIG. 7A corresponds to step 600, when the vehicle is placed at the corner of the lawn. FIG. 7B corresponds to step 610, when the vehicle moves forward, takes a photo of the boundary, and feeds the photo through the neural network to generate the neural network outputs described above. FIGS. 7C and 7D correspond to step 620, when the vehicle corrects the angular misalignment and the lateral offset before continuing to move forward. In an alternative use case, the downward-facing camera may take the photo while the vehicle is moving in order to provide correction without stopping the vehicle.

When a corner is not detected, the vehicle continues to moved forward incrementally while taking photos and correcting as appropriate, until a corner is detected, as shown in FIG. 7E. Upon detection of the corner, the vehicle moves forward as shown in FIG. 7F by a factor determined in step 620 in order to be located on the corner. Once the vehicle arrives at the corner, the vehicle turns as shown in FIG. 7G by a factor determined in step 620 through algorithmic processing control of the movement wheels of the vehicle in order to be aligned with the new line of the detected corner.

LAWN MOWING: For the mowing task, the chassis may utilize the one or more cutting lines 135 attached to the first rotating wheel 130 in order to cut grass 320 within the perimeter of a user-designated zone to a height determined by user input within the user interface 310. A path to cut the grass within the perimeter of the zone may be determined by the computer or based on user input. Correction of a mowing task may be performed as described in further detail below. Such correction may be performed when it is determined that the mowing task does not satisfy a user-selected condition, such as a condition related to a length of grass.

ORNAMENTAL OR GARDEN WEEDING: Further, the robot may also have a module for weed removal in a zone having ornamental plants or a zone having garden (i.e. fruit or vegetable) plants. These ornamental and garden zones will need to be mapped separately so that the robot knows which perimeters it is supposed to remove weeds from. Within these zones, the robot will need to identify plants that are desirably part of the ornamental zone or the garden zone and plants that are weeds. Then the robot may navigate to the weeds to remove them. To identify weeds in an image, an image or a portion of the image will be run through a deep neural network, for example, a convolutional neural network (CNN) trained in the manner discussed above.

This CNN may be modified to work with one-shot learning, where selected classification layers are cut off and a last layer is used to compute a similarity or distance measurement against the last layer computed from previously stored images that have been classified as weeds or non-weeds. The modified CNN approach can also use Siamese networks, few-shot learning, or triplet loss (positive, negative, and anchor examples).

If an image is similar to images determined to contain weeds, then the weed will be cut. If the image is similar to images determined to contain a desirable plant, then the system may determine a priority of the desirable plant in order to generate a closeness value representing a distance to be maintained between the robot and the desirable plant. The priority and/or closeness value associated with a desirable plant may be input using the user interface. The user interface may display a closest path to plants for cutting the ornamental and garden areas. The user can specify for certain areas some closeness values to plants to move the robot closer or father away from plants during the closest cutting path to the plants.

Using inputs and outputs of ICP, YOLO, and ORB-SLAM algorithms, a 3D model of a lawn, ornamental area, garden, and/or surrounding environment may be created. Moreover, the system may create a 3D ideal model of how each zone should appear after edging, cutting, weeding, etc. If grass or weeds extend beyond parameters of the 3D ideal model, the system may immediately go to those areas and edge, cut, or weed again to correct for the discrepancies with the 3D ideal model. Information regarding the corrections may be stored so that during subsequent performance of the task, the system can adjust for areas where corrections were determined to be needed. If the grass, weeds, bushes, trees, or other plants were cut too much compared to the 3D ideal model, corrections may be performed during the subsequent performance of the task without immediate correction.

YOLO may be used to recognize temporary objects that are not permanent in a 3D model, like cars, people, and pets. These areas are masked out in images and not used when creating the 3D model or ideal 3D model of the lawn, ornamental area, garden, and surrounding environment. YOLO may also be used for object avoidance to avoid running into hazards like cars, people, pets, and other objects.

ORB and YOLO may also be used in tandem to increase the accuracy of the SLAM algorithm by recognizing points in space that do not move, such as trees, bushes, houses, house corners, and stationary objects like poles and fire hydrants. Using YOLO or a deep neural network, flowers, bushes, ornamental plants, and garden plants can be recognized in order to try to avoid cutting them by maintaining the distance determined according to the user-selected priority and/or closeness value.

The user can use the user interface to capture images of their desirable plants so that the robot will try to avoid cutting them. The robot may use similarity clustering to recognized these plants. This training data can also be added to the deep learning model in future versions of the model. The user can specify a distance to stay away from cutting these plants.

By using location data and similarity clustering, the robot can automatically capture more training data that is similar to past training data. Furthermore, the robot can automatically learn new weeds by seeing what grows in areas that only weeds should grow. These new weeds can be presented to the user for confirmation or rejection via the user interface, and the feedback provided by the user can be used for future learning of which plants the user considers to be desirable in each zone.

While moving, the robot may also attempt to avoid hazard areas that are too steep, too bumpy, too narrow, or too blocked to move through. The robot can use texture recognition, clustering, IMU/GPS, 3D maps, ORB feature recognition, and/or sensors such as an accelerometer or other tilt sensor for tilt sensing to determine if an area should not be entered. If the robot enters the area and the self-positioning module such as IMU or SLAM indicates the robot is not moving appropriately, then the robot can save this information to help make the decision to avoid the area in the future. This decision can also be provided to the user via the user interface.

A generative adversarial network (GAN) can also be used as a neural network to create more training data. By clustering similar training images, these images can be run through a GAN neural network to produce many more training images to increase the accuracy of deep learning algorithms during retraining.

Algorithms and deep neural networks used in the processing noted above may be updated through the internet or other network with future versions. Training data can be uploaded to internet servers to create new algorithms and deep learning models for subsequent use by the same motorized wheeled chassis or by other autonomous vehicles.

Depending upon the processing power available using the on-board electronic components, it is possible to offload some tasks to another processor, such as a CPU or GPU provided on a base station or internet server.

In an embodiment, a Kalman filter may be added to the self-positioning module to improve 3D position recognition of robot. Some of the steps described above may be skipped, and instead of obtaining new data when steps are skipped, cached values may be used, reordered, or repeated to optimize performance and use of computing resources.

During an initial setup mode or a subsequent training, a user may use the user interface to drive a robot around a perimeter to create one or more geofences. Multiple geofences may be created for a lawn zone, ornamental plant zone, garden zone, or sub-areas within each zone. Repeated training may be used to increase accuracy for the robot traversing the geofence autonomously.

The user interface may also be used to create anchor points in a map that define portions of each geofence border location. The user can also move the anchor points to manually adjust the geofence border location after the anchor points are created by the user or through processing performed by the robot.

As described above, the robot may use YOLO, deep learning models, and/or similarity clustering to locate (1) trees, ornamental plants, flowers, and garden plants to avoid cutting and (2) weeds to cut. Using the user interface, the user can add, delete, or modify classification of plants as desired.

As noted above, a robot may primarily use SLAM to move along outer edge of geofence. After the robot completes a loop, the robot may move to the next loop within geofence. The robot may then move to more inner loops, when it is determined nothing needs cutting withing a current loop or partial loop.

When the robot recognizes a hazard as described above using the outward-facing camera(s), the robot may cease operations entirely or adjust its path to avoid the obstacle, depending on a size of the hazard and whether the hazard is stationary or moving.

When the robot recognizes a weed as described above, robot uses one or both rotating wheels to remove the weed. When the robot recognizes a desirable plant such as a tree, flower, ornamental plant, or garden plant as described above, the robot may stay away from the desirable plant by at least a distance determined according to a closeness value that is set as described above.

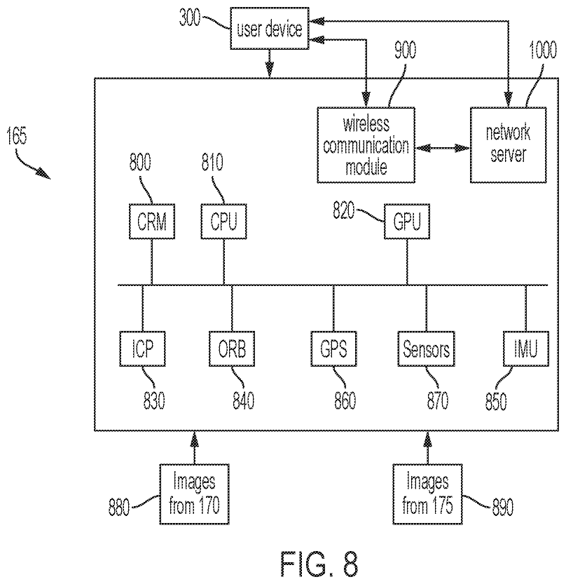

FIG. 8 illustrates an example of electronic components 165 that may be provided on a motorized wheeled chassis according to an embodiment illustrated in FIG. 1. In FIG. 8, a non-transitory computer-readable storage medium 800 may store a program to execute processing related to the processes discussed above. A computer of the electronic components according to an embodiment may include a CPU 810 and a GPU 820. The computer may be configured to execute the program stored on the non-transitory computer-readable storage medium 800.

An ICP module 830 and an ORB module 840 may be used with a SLAM module that operates based on inputs received from an IMU 850. Self-positioning of the vehicle may also be implemented via GPS 860. Additional sensors 870 may include a tilt sensor, which can be implemented by an accelerometer.

The electronic components are configured to receive images from the outward-facing camera(s) 170 and the downward-facing camera(s) 175. The received images may be stored in a SLAM library in association with positional information, and the SLAM library may be stored in the non-transitory computer-readable storage medium 800 and/or in external storage such as a network server 1000. The electronic components may also be configured to communicate in a bidirectional manner via wireless communication module 900 with an external computing device such as user device 300 and/or the network server 1000. Moreover, the electronic components may communicate with other external computing resources via a network.

Embodiments of the present technology are not limited to the above-described embodiment(s), and various modifications can be made without departing from the scope of the present technology. Note that the effects described in the present description are merely examples. The effects of the present technology are not limited to those described above, and the present technology may have effects other than those described in the present description.

1. An autonomous vehicle for performing gardening tasks, comprising:
a motorized wheeled chassis including a plurality of wheels and at least one motor providing power to the plurality of wheels;
at least one rotating wheel attached to the motorized wheeled chassis;
at least one line or blade extending from the at least one rotating wheel, the at least one line or blade configured to perform a selected gardening task;
at least one of a downward-facing camera attached to the motorized wheeled chassis or an outward-facing camera attached to the motorized wheeled chassis; and
a processor configured to control processing related to
determining a position of the motorized wheeled chassis,
driving the at least one motor to move one or more of the plurality of wheels,
rotating the at least one rotating wheel when the selected gardening task is performed, and
correcting a path of the motorized wheeled chassis based on one or more images obtained from the at least one of the downward-facing camera or the outward-facing camera.

2. The autonomous vehicle according to claim 1,
wherein the position of the motorized wheeled chassis is initially determined using information obtained from at least one of an inertial measurement unit (IMU) or a global positioning system (GPS) receiver.

3. The autonomous vehicle according to claim 2,
wherein the at least one of the IMU or the GPS receiver is used to determine the path of the motorized wheeled chassis before the path of the motorized wheeled chassis is corrected.

4. The autonomous vehicle according to claim 3,
wherein the one or more images obtained from the at least one of the downward-facing camera or the outward-facing camera are stored in a simultaneous location and mapping (SLAM) library.

5. The autonomous vehicle according to claim 4,
wherein the one or more images obtained from the at least one of the downward-facing camera or the outward-facing camera are stored in the SLAM library in association with positional information determined using the at least one of the IMU or the GPS receiver.

6. The autonomous vehicle according to claim 1,
wherein the at least one rotating wheel includes
a first rotating wheel configured to perform a mowing task using at least one cutting line or blade, and
a second rotating wheel configured to perform an edging task using at least one edging line or blade.

7. The autonomous vehicle according to claim 6,
wherein at least one of the first rotating wheel or the second rotating wheel is configured to perform a weeding task.

8. The autonomous vehicle according to claim 7,
wherein the weeding task is performed by the at least one of the first rotating wheel or the second rotating wheel based on identification of a weed using the one or more images obtained from the at least one of the downward-facing camera or the outward-facing camera.

9. The autonomous vehicle according to claim 8,
wherein the identification of the weed is performed by object recognition processing controlled by the processor.

10. The autonomous vehicle according to claim 8,
wherein the identification of the weed is confirmed by communication with a user device.

11. The autonomous vehicle according to claim 10,
wherein the identification of the weed is confirmed using a user interface displayed on the user device, the user interface including display of the one or more images obtained from the at least one of the downward-facing camera or the outward-facing camera.

12. The autonomous vehicle according to claim 1,
wherein each image obtained from the at least one outward-facing camera includes depth data.

13. The autonomous vehicle according to claim 12,
wherein the depth data included in each image obtained from the at least one outward-facing camera is stored in a SLAM library.

14. The autonomous vehicle according to claim 1,
wherein the path of the motorized wheeled chassis is corrected using outputs of a neural network, the neural network being configured to use the one or more images obtained from the at least one of the downward-facing camera or the outward-facing camera as one or more inputs.

15. The autonomous vehicle according to claim 14,
wherein the outputs of the neural network include
an angular value indicating a degree of misalignment of the motorized wheeled chassis with respect to a boundary, and
a scalar value indicating an amount of lateral offset of the motorized wheeled chassis with respect to the boundary.

16. The autonomous vehicle according to claim 15,
wherein the outputs of the neural network further include
a value indicating whether a corner is detected,
a scalar value indicating a distance to the detected corner, and
a scalar value indicating an angle of the detected corner.

17. The autonomous vehicle according to claim 14,
wherein the neural network is configured to use images obtained from the at least one downward-facing camera as inputs, and
wherein the images obtained from the at least one downward-facing camera includes portions of a boundary where an edging task has been performed.

18. The autonomous vehicle according to claim 1,
wherein the determined position of the motorized wheeled chassis is confirmed using a loop closure algorithm, and
wherein the loop closure algorithm determines whether the position of the motorized wheeled chassis coincides with a previously determined position of the motorized wheeled chassis.

19. A method for controlling an autonomous vehicle performing gardening tasks, the method comprising:
obtaining one or more images from at least one of a downward-facing camera attached to a motorized wheeled chassis or an outward-facing camera attached to the motorized wheeled chassis;
determining a position of the motorized wheeled chassis;
driving at least one motor to move one or more wheels of the motorized wheeled chassis;
rotating at least one rotating wheel when a selected gardening task is performed; and
correcting a path of the motorized wheeled chassis based on the one or more images obtained from the at least one of the downward-facing camera or the outward-facing camera.

20. A non-transitory computer-readable storage medium having embodied thereon a program, which when executed by a computer causes the computer to execute a method, the method comprising:
obtaining one or more images from at least one of a downward-facing camera attached to a motorized wheeled chassis or an outward-facing camera attached to the motorized wheeled chassis;
determining a position of the motorized wheeled chassis;
driving at least one motor to move one or more wheels of the motorized wheeled chassis;
rotating at least one rotating wheel when a selected gardening task is performed; and
correcting a path of the motorized wheeled chassis based on the one or more images obtained from the at least one of the downward-facing camera or the outward-facing camera.
